(19) United States
(12) Patent Application Publication
(10) Pub. No.: US 2026/0237795 A1
(43) Pub. Date: Aug. 13, 2026

(54) SIDE WING FOLDING DEVICE FOR POUCH-TYPE SECONDARY BATTERY AND SIDE WING FOLDING METHOD FOR POUCH-TYPE SECOND BATTERY USING SAME

(71) Applicant: HUMIN ROBOTICS CO., LTD., Cheonan-si, Chungcheongnam-do (KR)

(72) Inventors: Seong Joon OH, Cheonan-si (KR); Jae Seon CHOE, Cheonan-si (KR)

(73) Assignee: HUMIN ROBOTICS CO., LTD., Cheonan-si, Chungcheongnam-do (KR)

(21) Appl. No.: 18/707,644

(22) PCT Filed: May 25, 2023
(86) PCT No.: PCT/KR2023/007201

§ 371 Date: Apr. 22, 2026

(30) Foreign Application Priority Data
Apr. 14, 2023 (KR) 10-2023-0049143

(51) Int. Cl. H01M 50/105; H01M 10/04

(52) U.S. Cl. CPC H01M 50/105; H01M 10/0404

(57) ABSTRACT

Proposed is a device for folding a side wing of a pouch-type secondary battery. The device includes an upper folding blade configured to move up and down and having a first inclined surface formed on a lower end part thereof, a lower folding blade located under the upper folding blade, configured to move up and down, and having a second inclined surface formed on an upper end part thereof, a folding block located at an opposite side of the pouch-type secondary battery relative to the upper folding blade and the lower folding blade and configured to move up, down, left, and right, and a press block located above the folding block at an opposite side of the pouch-type secondary battery relative to the upper folding blade and the lower folding blade and configured to move up, down, left, and right.

### TECHNICAL FIELD

The present disclosure relates to a device for folding a side wing of a pouch-type secondary battery and, more specifically, to a folding device that can perform primary folding and secondary folding with one device to prevent the exposure of the cut surface of a pouch.

### Background Art

Generally, a secondary battery is a chemical battery that can repeat charging and discharging by using reversible mutual conversion of chemical energy and electrical energy.

High-performance secondary batteries include Ni-MH secondary batteries and lithium secondary batteries. Lithium secondary batteries include lithium metal secondary batteries, lithium-ion secondary batteries (square, cylindrical, pouch-shaped), lithium-ion polymer secondary batteries, and lithium polymer secondary batteries, etc. Recently, as electric vehicles have become commercialized, with the development of large lithium secondary batteries for electric vehicles, research on automation equipment for mass production thereof are actively underway.

Among lithium-ion secondary batteries, a pouch-type battery is especially easy to modify the shape thereof. Furthermore, a pouch-type battery is low in manufacturing cost and light in weight, and thus the demand for the pouch-type battery is increasing. In a pouch-type secondary battery, a pouch (a battery cover sheet) is an aluminum thin film having opposite surfaces coated with PE and PP. When the pouch is cut during battery manufacturing, an aluminum layer on the cut surface is exposed to the outside, making electrical insulation of the pouch difficult. Accordingly, a folding process is performed on a side wing extending to a side of a body of the pouch so that the cross section of the pouch of a pouch-type secondary battery is not exposed.

In general, a folding process for a pouch-type secondary battery includes a process of folding an end part of a pouch to 180° to prevent the exposure of a cut surface thereof (hereinafter referred to as ‘primary folding’) and a process of folding a side wing, which extends outward, toward the body while the end part is folded (hereinafter referred to as ‘secondary folding’). In each of these first and second folding processes, the side wing is folded through several steps. In the past, the folding process was performed by applying a plurality of devices in the process of performing the several steps, so the process of moving the devices through the folding steps was very complicated. Recently, a folding apparatus in which a primary folding process can be performed with a single device has been developed, but it is not possible to perform the first and second folding processes with a single device.

### DISCLOSURE

### Technical Problem

The present disclosure has been made to solve the above-mentioned problems occurring in the prior art, and is intended to provide a folding device that can perform primary folding and secondary folding with one device.

### Technical Solution

In order to accomplish the above objectives, a side wing folding device for a pouch-type secondary battery according to an aspect of the present disclosure includes: an upper folding blade configured to move up and down and having a first inclined surface formed on a lower end part thereof, the first inclined surface slanting from an upper part of the lower end part directed to a body of the pouch-type secondary battery toward an outer lower part thereof; a lower folding blade located under the upper folding blade, configured to move up and down, and having a second inclined surface formed on an upper end part thereof, the second inclined surface slanting from an upper part of the upper end part directed to the body of the pouch-type secondary battery toward an outer lower part thereof; a folding block located at an opposite side of the pouch-type secondary battery relative to the upper folding blade and the lower folding blade and configured to move up, down, left, and right, with the folding block having a first horizontal surface formed on an upper part thereof; and a press block located above the folding block at an opposite side of the pouch-type secondary battery relative to the upper folding blade and the lower folding blade and configured to move up, down, left, and right, with the press block having a third horizontal surface formed on a lower part thereof, wherein the folding block comprises a vertical surface formed on an end part of a side surface thereof directed to the body of the pouch-type secondary battery with the vertical surface being connected to the first horizontal surface, a third inclined surface formed under the vertical surface with the third inclined surface slanting from an upper part thereof directed to the body of the pouch-type secondary battery toward an outer lower part thereof, wherein the third inclined surface is formed to be apart by a predetermined distance outward from the vertical surface, and a fourth horizontal surface located between the vertical surface and the third inclined surface, and the first inclined surface and the second inclined surface are configured to be engaged with each other, and the second inclined surface and the third inclined surface are configured to be engaged with each other.

In a primary folding process in which an end part of the side wing is folded to 180°, when the side wing is located between the first inclined surface of the upper folding blade and the second inclined surface of the lower folding blade and is deformed by being pressed, the first horizontal surface of the folding block located outside the lower folding blade may be located under and support the side wing and form two bent parts on the side wing, when the end part of the side wing is folded upward while the folding block is moved upward, one of the two bent parts may be bent to an angle less than 90° by an angle between the first inclined surface of the upper folding blade, the second inclined surface of the lower folding blade, and the vertical surface of the folding block, and when the side wing is folded and pressed by the second inclined surface of the lower folding blade and the third inclined surface of the folding block, the bent part that is bent to an angle less than 90° may be folded to 180°.

In a secondary folding process in which the side wing with an end part folded to 180° is folded toward the body of the secondary battery, when the side wing is located between the first inclined surface of the upper folding blade and the second inclined surface of the lower folding blade and is deformed by being pressed, the first horizontal surface of the folding block located outside the lower folding blade may be located under and support the side wing and forms two bent parts on the side wing, when the end part of the side wing is folded upward while the folding block is moved upward, the folding block may be moved upward with the upper folding blade raised, and the end part of the side wing folded to 180° may be folded toward the body of the secondary battery, and when the vertical surface of the folding block presses the side wing, which is folded upward, toward the body, the vertical surface of the folding block may protrude more inward than the lower folding blade, and bring the end part of the side wing folded to 180° into close contact with the body of the secondary battery.

According to another aspect of the present disclosure, a side wing folding method for a pouch-type secondary battery to perform the primary folding of folding the end part of the side wing to 180° by using the folding device includes: forming the two bent parts on the side wing by supporting the side wing by the first horizontal surface of the folding block located outside the lower folding blade and under the side wing by locating the side wing between the first inclined surface of the upper folding blade and the second inclined surface of the lower folding blade to press and deform the side wing; bending one of the two bent parts to an angle less than 90°by an angle between the first inclined surface of the upper folding blade, the second inclined surface of the lower folding blade, and the vertical surface of the folding block while the end part of the side wing is folded upward while the folding block is moved upward; and folding the bent part, which is bent to an angle less than 90°, to 180° by folding and pressing the side wing by the second inclined surface of the lower folding blade and a third inclined surface of the folding block.

Next, the method may further include: pressing the side wing, which has the bent part folded to 180°, between the first horizontal surface of the folding block and a second horizontal surface of the press block afterward.

According to still another aspect of the present disclosure, the side wing folding method for a pouch-type secondary battery to perform secondary folding of folding a side wing having an end part folded to 180° toward a body of the secondary battery by the folding device includes: forming the two bent parts on the side wing by supporting the side wing by the first horizontal surface of the folding block located outside the lower folding blade and under the side wing by locating the side wing between the first inclined surface of the upper folding blade and the second inclined surface of the lower folding blade to press and deform the side wing; folding the end part of the side wing folded to 180° toward the body of the secondary battery after folding the end part of the side wing upward while the folding block is moved upward with the upper folding blade raised; and bringing the end part of the side wing folded to 180° into close contact with the body of the secondary battery by protruding the vertical surface of the folding block more inward than the lower folding blade while the vertical surface of the folding block presses the side wing, which is folded upward, toward the body.

### Advantageous Effects

The folding device of the present disclosure configured as described above uses the inclined surfaces of the upper and lower folding blades and the horizontal surface of the folding block to pre-bend the side wing to an acute angle less than 90°, thereby facilitating the process of folding the side wing to 180°.

In addition, there is an excellent effect in that the primary folding of folding the end part of the side wing to 180° and the secondary folding of bringing the end part of the side wing folded to 180° into close contact with the body of a secondary battery by the inclined surface formed on the folding block and the vertical surface located by protruding compared to the inclined surface can be performed in one folding device.

### DESCRIPTION OF DRAWINGS

FIG. 1 is a view illustrating the structure of a side wing folding device for a pouch-type secondary battery according to an embodiment of the present disclosure.

FIGS. 2 to 8 are views illustrating a process in which the side wing folding device for a pouch-type secondary battery according to the embodiment of the present disclosure performs primary folding.

FIGS. 9 to 16 are views illustrating a process in which the side wing folding device for a pouch-type secondary battery according to the embodiment of the present disclosure performs secondary folding.

### DESCRIPTION OF THE REFERENCE NUMERALS IN THE DRAWINGS

100: Upper folding blade
110: First inclined surface
200: Lower folding blade
210: Second inclined surface
300: Folding block
310: First horizontal surface
320: Vertical surface
330: Third inclined surface
340: Fourth horizontal surface
400: Press block
410: Second horizontal surface
1000: Body
1100: Side wing
1110: First bent part
1120: Second bent part
1130: Third bent part
1140: Fourth bent part
   7

### BEST MODE

An embodiment according to the present disclosure will be described in detail with reference to the accompanying drawings.

However, the embodiment of the present disclosure may be modified into various different forms, and the scope of the present disclosure is not limited to the embodiment described below. The shapes and sizes of elements in the drawings may be exaggerated for clearer explanation, and elements indicated by the same reference numerals in the drawings are the same elements.

In addition, throughout the specification, when a part is described to be “connected” to another part, this includes not only a case in which the parts are “directly connected” to each other but also a case in which the parts are “electrically connected” to each other with another element between the parts. In addition, when a part is described to “include” or “have” a certain component, this means that the part does not exclude other components but may further include or have other components, unless specifically stated to the contrary.

Additionally, terms such as “first” and “second” are used to distinguish one component from another component, and the scope of the claims should not be limited by these terms. For example, a first component may be named a second component, and similarly, the second component may also be named the first component.

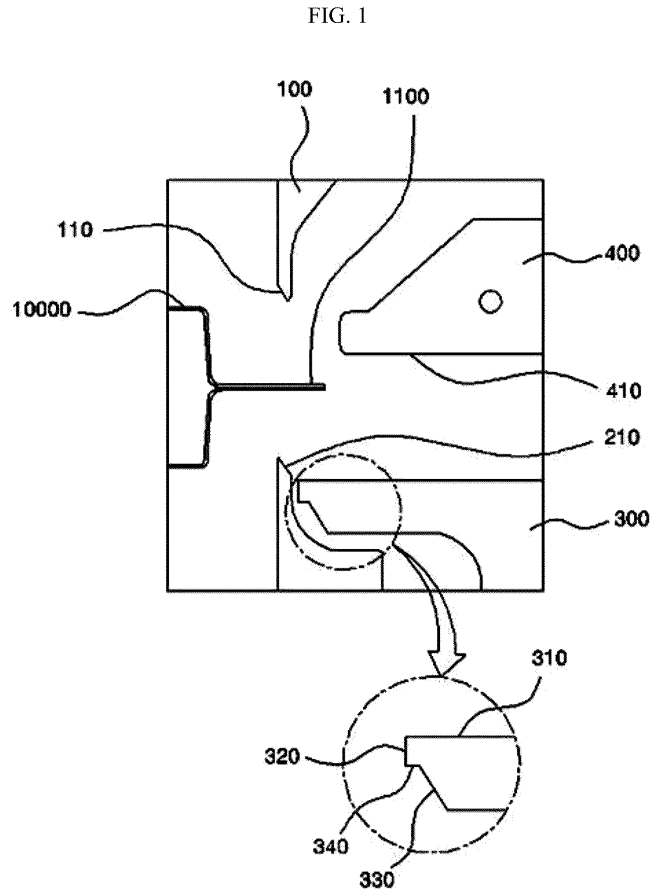

FIG. 1 is a view illustrating the structure of a side wing folding device for a pouch-type secondary battery according to an embodiment of the present disclosure.

The side wing folding device for a pouch-type secondary battery according to the embodiment includes an upper folding blade 100, a lower folding blade 200, a folding block 300, and a press block 400.

The side wing folding device for a pouch-type secondary battery of the embodiment is a device that folds a side wing 1100 extending laterally from a body 1000 of a secondary battery, and when describing a direction in this specification, a side directed to the body 1000 of a secondary battery is expressed as the inside, and a side away from the body 1000 of a secondary battery is expressed as the outside.

The upper folding blade 100 and the lower folding blade 200 are respectively located at the upper and lower sides of the side wing 1100, and the lower end part of the upper folding blade 100 and the upper end part of the lower folding blade 200 are arranged at locations corresponding to each other.

The lower end part of the upper folding blade 100 has a first inclined surface 110 sloping from an inner upper side thereof toward an outer lower side thereof, and the upper end part of the lower folding blade 200 has a second inclined surface 210 sloping from an inner upper side thereof toward an outer lower side thereof so that the first inclined surface 110 and the second inclined surface 210 are configured to face each other.

The folding block 300 and the press block 400 are located outside the upper folding blade 100 and the lower folding blade 200. The folding block 300 is arranged at the lower side and the press block 400 is arranged at the upper side.

A flat first horizontal surface 310 is formed on the upper surface of the folding block 300, and a flat second horizontal surface 410 is formed on the lower surface of the press block 400.

In addition, the folding block 300 includes a vertical surface 320 formed on an end part of the inner side surface thereof with the vertical surface being connected to the first horizontal surface 310, and a third inclined surface 330 formed under the vertical surface 320 with the third inclined surface slanting from an inner upper part thereof toward an outer lower part thereof, wherein the third inclined surface 330 is configured to face the second inclined surface 210. Meanwhile, the third inclined surface 330 is formed to be apart by a predetermined distance outward from the vertical surface 320, and a fourth horizontal surface 340 is located between the vertical surface 320 and the third inclined surface 330.

The structure including the upper folding blade 100, the lower folding blade 200, the folding block 300, and the press block 400, and the structure including the first inclined surface 110 and the second inclined surface are similar to those of Korea Patent No. 10-2435179 filed by the applicant of the present disclosure. However, according to the present disclosure, the folding block 300 has the third inclined surface 330 and the fourth horizontal surface 340, and can perform processes that could not be performed in the prior art, thereby having excellent effect of being able to perform both a primary folding and a secondary folding in one device.

Hereinafter, the operation of the side wing folding device for a pouch-type secondary battery according to the embodiment of the present disclosure will be described by being divided into the primary folding and the secondary folding.

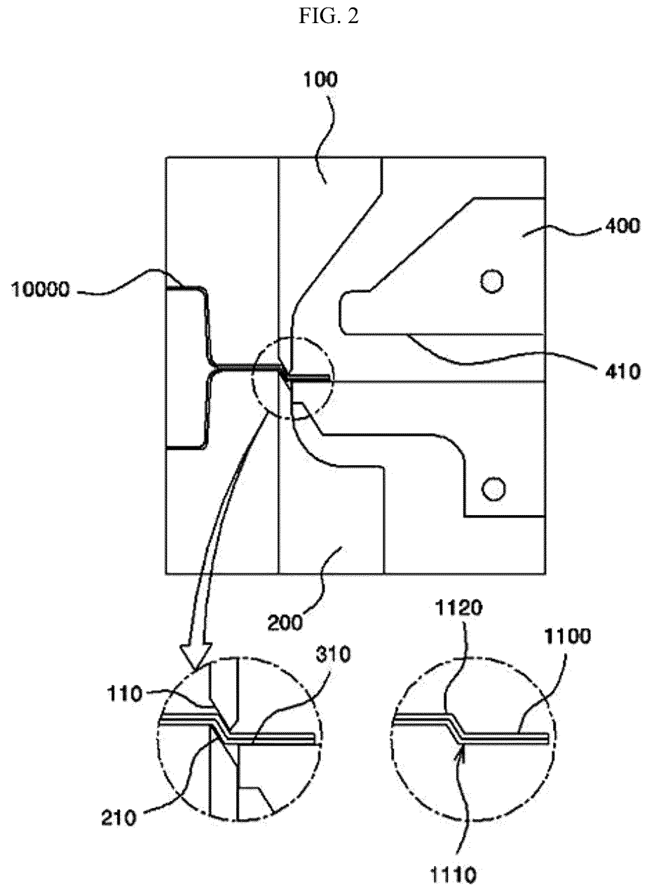

FIGS. 2 to 8 are views illustrating a process in which the side wing folding device for a pouch-type secondary battery according to the embodiment of the present disclosure performs the primary folding.

First, as illustrated in FIG. 2, the upper folding blade 100 and the lower folding blade 200 are operated so that the first inclined surface 110 of the upper folding blade 100 and the second inclined surface 210 of the lower folding blade 200 are engaged with each other at a predetermined position of the side wing 1100.

In this case, the upper folding blade 100 and the folding block 300 located inside the lower folding blade 200 are located so that the height of the first horizontal surface 310 is equal to or higher than the height of the outer end of the first inclined surface 110. Due to the engagement of the first inclined surface 110 and the second inclined surface 210 and the position of the first horizontal surface 310, a first bent part 1110 and a second bent part 1120 are formed on the outer and inner sides of the side wing 1100, respectively.

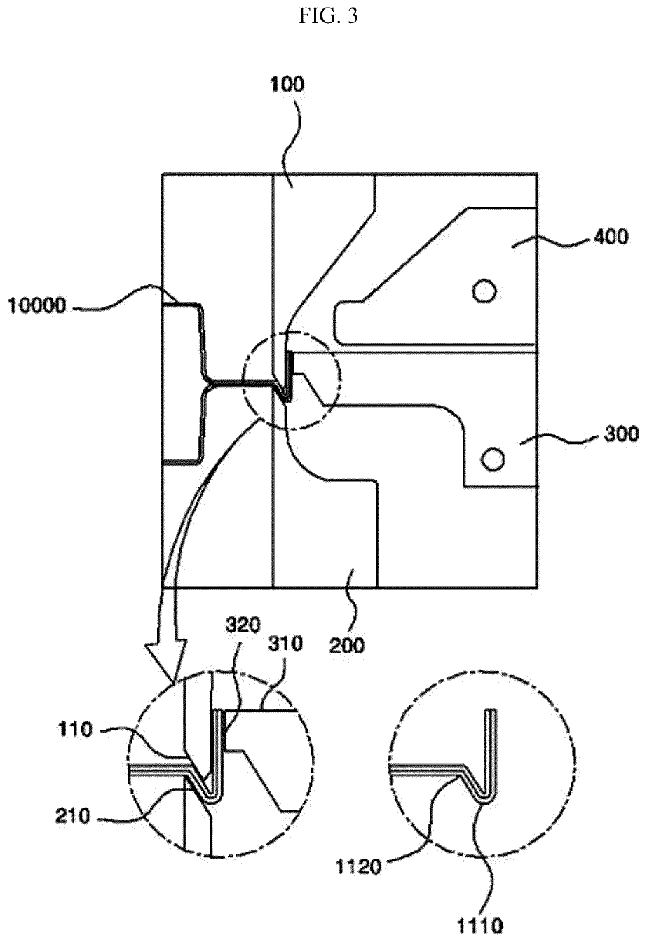

Next, as illustrated in FIG. 3, when the folding block 300 moves upward, the side wing 1100 is pressed by the vertical surface 320 of the folding block 300, and the first bent part 1110 is additionally bent. The first bent part 1110 is bent to an angle smaller than the horizontal (preferably about 120°) while being pressed by the first inclined surface 110 and the second inclined surface 210 in the previous step, and thus while the folding block 300 is raised, the first bent part 1110 is bent to an acute angle less than 90° (preferably about 30°). This is compared with a case in which when the folding block 300 is raised in a situation in which the first bent part 1110 is not formed by the first inclined surface 110 and the second inclined surface 210, the side wing 1100 can be bent only to a maximum angle of about 90° from a horizontally stretched state thereof.

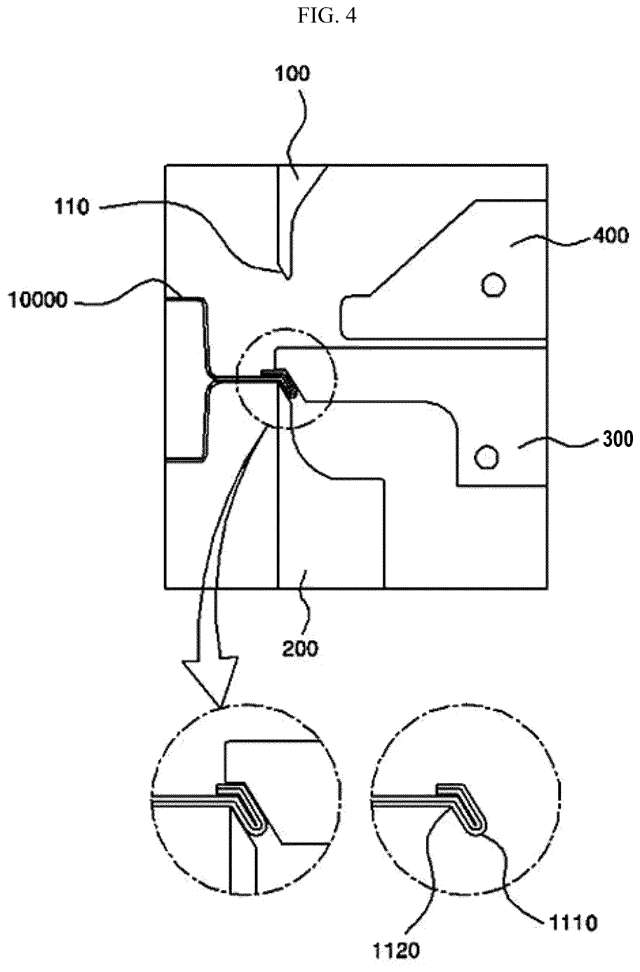

In addition, as illustrated in FIG. 4, when the upper folding blade 100 moves upward and the folding block 300 moves inward to engage the second inclined surface 210 and the third inclined surface 330 of the folding block 300 with each other, the side wing 1100 is pressed between the second inclined surface 210 and the third inclined surface 330, so that the first bent part 1110 is bent and folded to 180°. In this case, since the first bent part 1110 is bent to an acute angle less than 90° (preferably about 30°) in the previous step, the first bent part 1110 can be easily bent to 180° by the engagement of the second inclined surface 210 and the third inclined surface 330 with each other, with the first bent part 1110 being an end part. When the first bent part is bent to about 90° without the process of FIG. 2, it is difficult to immediately bend the first bent part to 180°, and during the process of folding to 180°, other parts are easily bent. However, in the present embodiment, the first bent part 1110 is bent to about 120° as illustrated in FIG. 2 and the first bent part 1110 is bent to about 30° as illustrated in FIG. 3, and accordingly, the process of bending the first bent part 1110 to 180° can be easily performed.

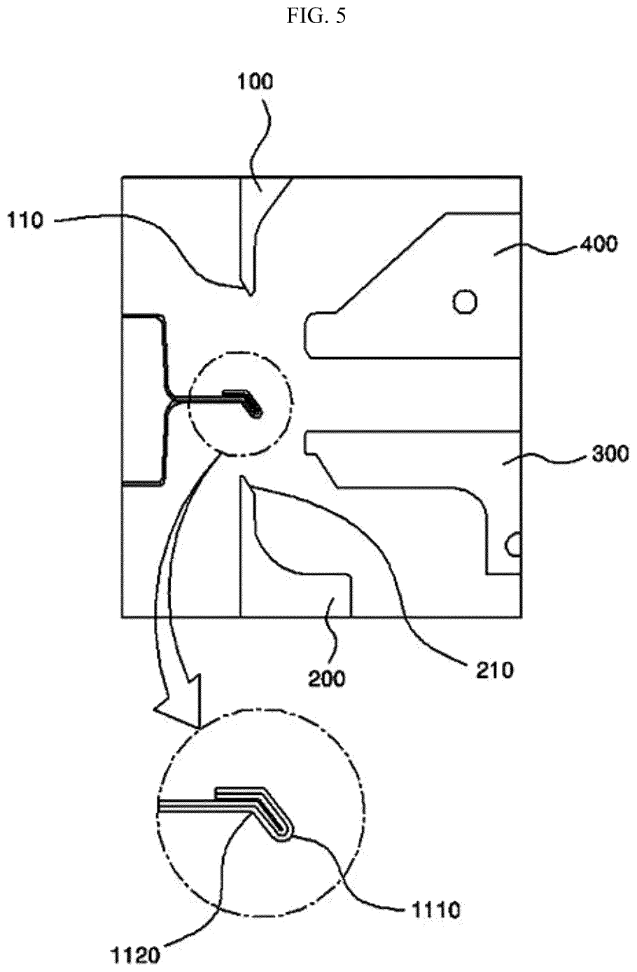

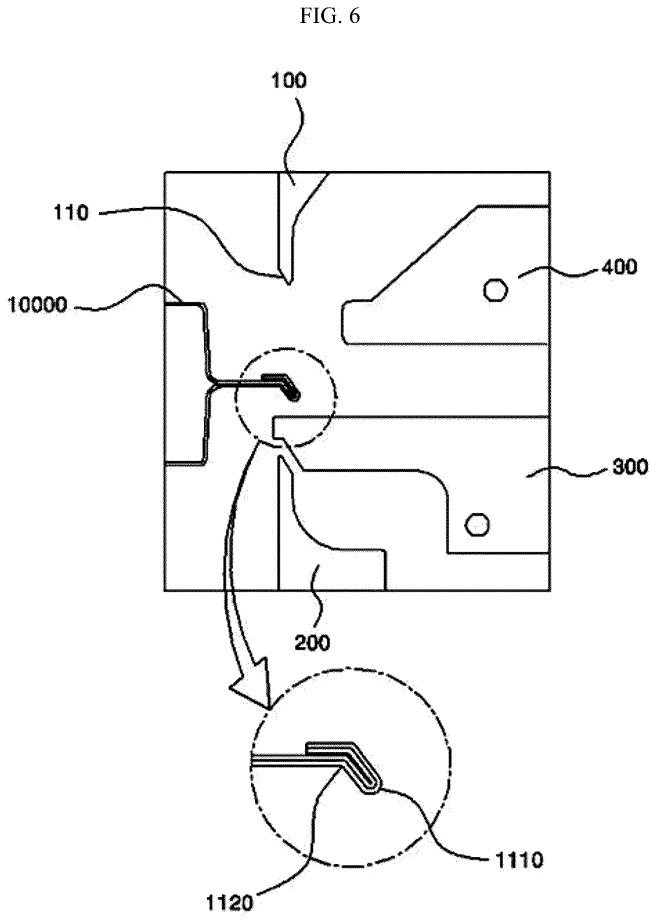

FIG. 5 illustrates that for a next operation, the lower folding blade 200 and the folding block 300 are located away from the side wing 1100, and afterwards, as illustrated in FIG. 6, the folding block 300 is moved so that the first horizontal surface 310 of the folding block 300 is located under the side wing 1100.

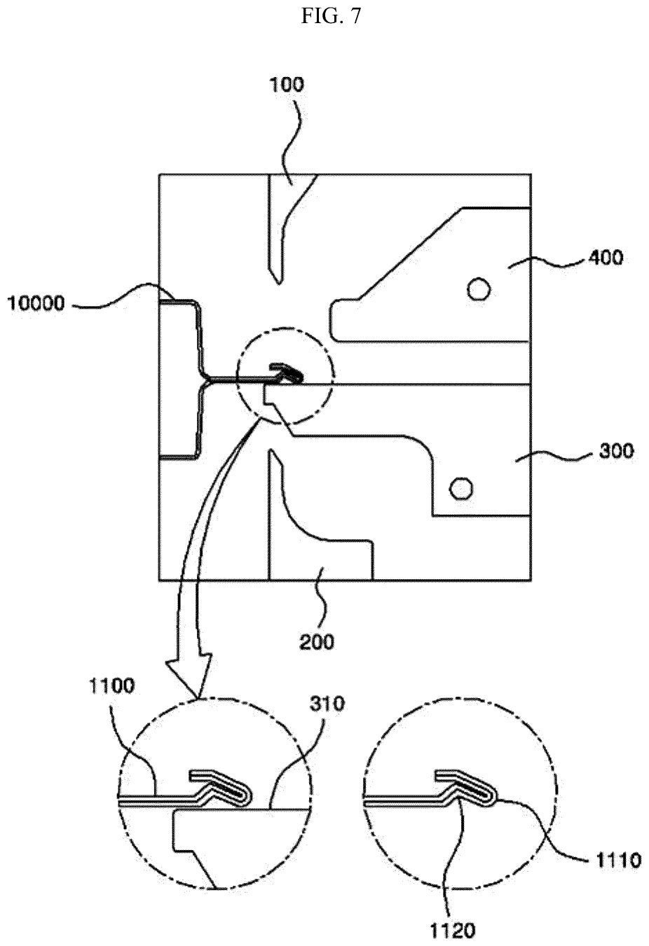

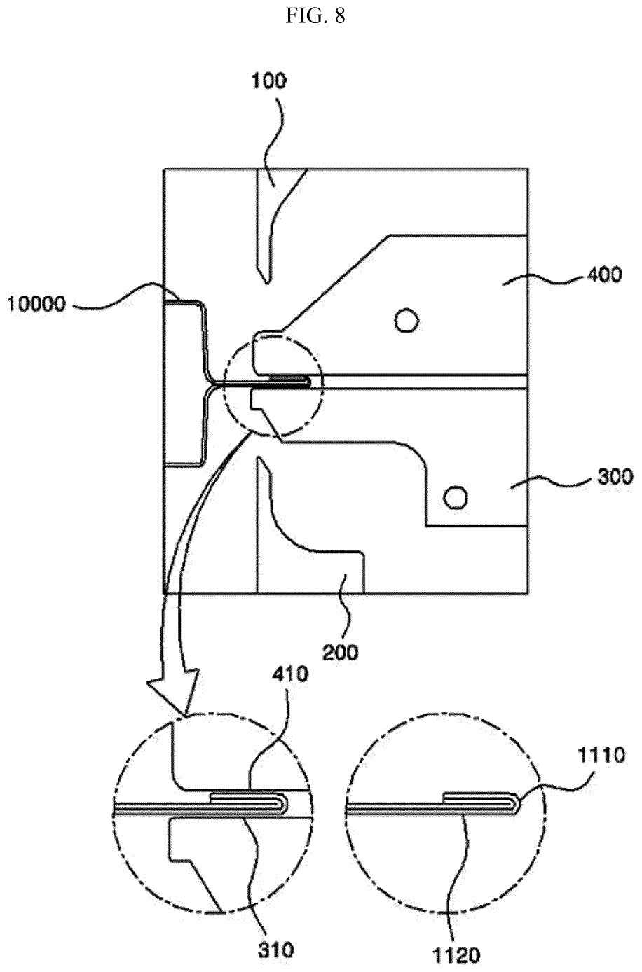

In addition, as illustrated in FIGS. 7 and 8, when the side wing 1100 is located on the first horizontal surface 310 of the folding block 300, the side wing 1100 is pressed by the second horizontal surface 410 of the press block 400 so that the first bent part 1110 bent to 180° can be folded more perfectly. This process completes the primary folding, which folds the end part of the side wing 1100 to 180°.

Through the above process, the primary folding of folding the end part of the cut pouch to 180° is performed. By first forming the first bent part 1110 through the first inclined surface 110 and the second inclined surface 210, the folding block 300 can bend the first bent part 1110 to an acute angle less than 90° (preferably about 30°). Accordingly, compared to a general folding device, the process of bending to 180° can be easily performed. In addition, the present disclosure differs from the prior application of the applicant of the present disclosure in that the first bent part 1110 is folded to 180° by using the second inclined surface 210 and the third inclined surface 330, and the folded part of the first bent part 1110 is pressed again through the pressing of the second horizontal surface 410 against the first horizontal surface 310, thereby allowing the primary folding to be more completely performed.

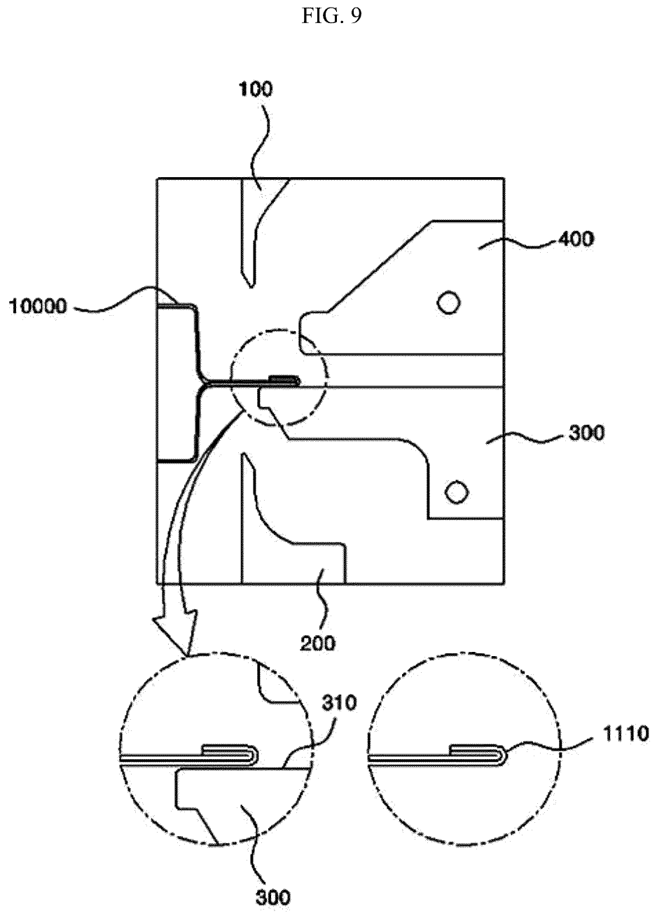

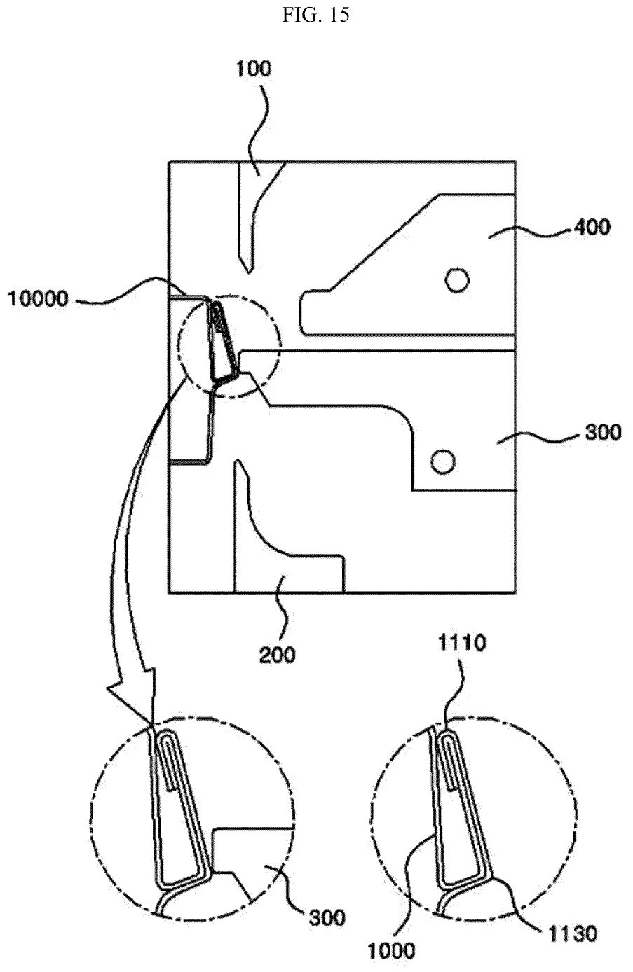

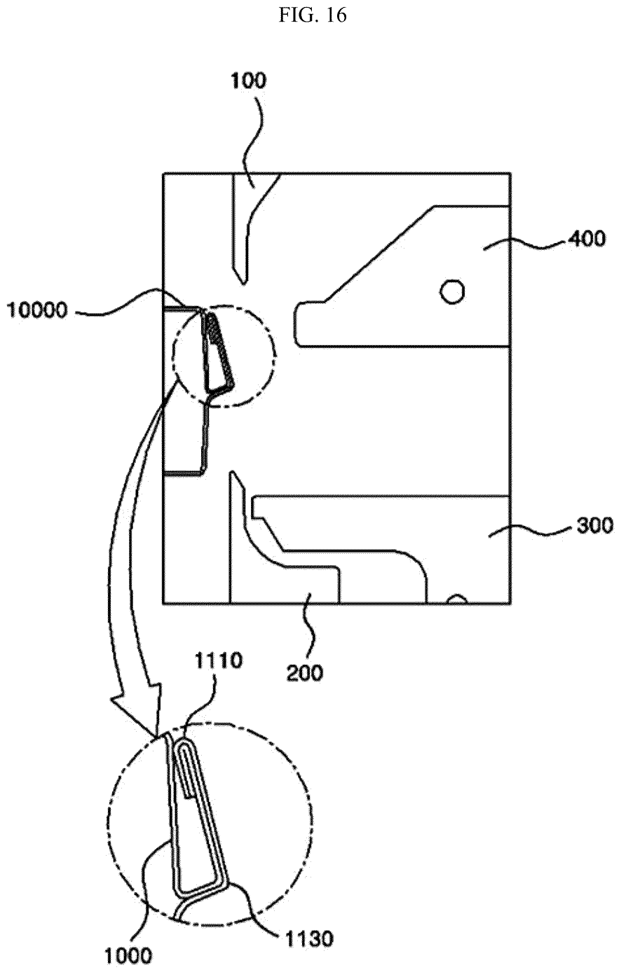

FIGS. 9 to 16 are views illustrating a process in which the side wing folding device for a pouch-type secondary battery according to the embodiment of the present disclosure performs the secondary folding.

Conventionally, a secondary folding was performed by moving a pouch-type secondary battery, on which a primary folding was performed, to another device, but the side wing folding device for a pouch-type secondary battery according to the present embodiment can continuously perform the secondary folding after the primary folding.

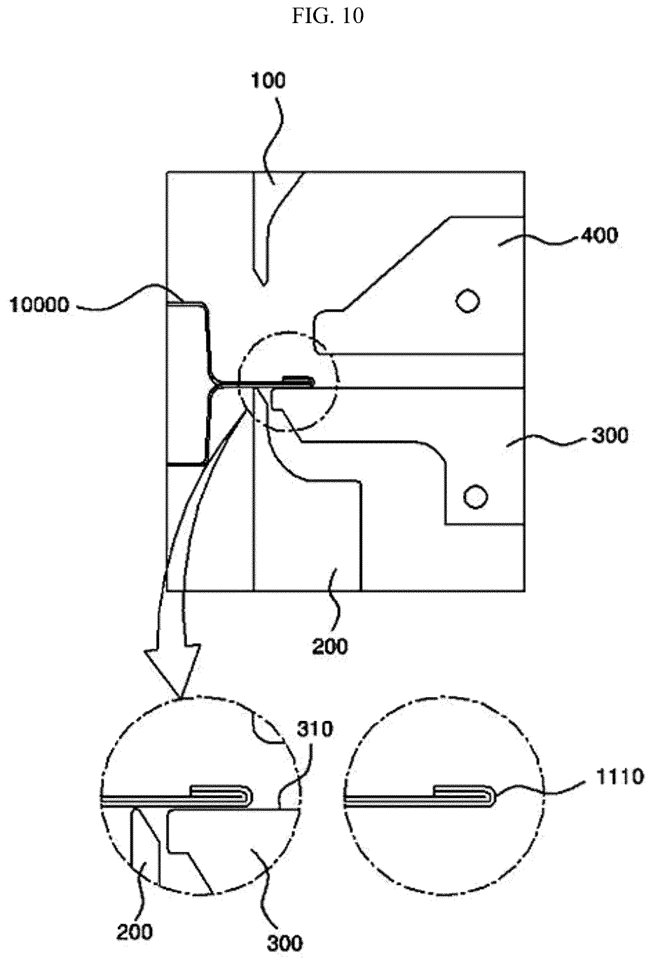

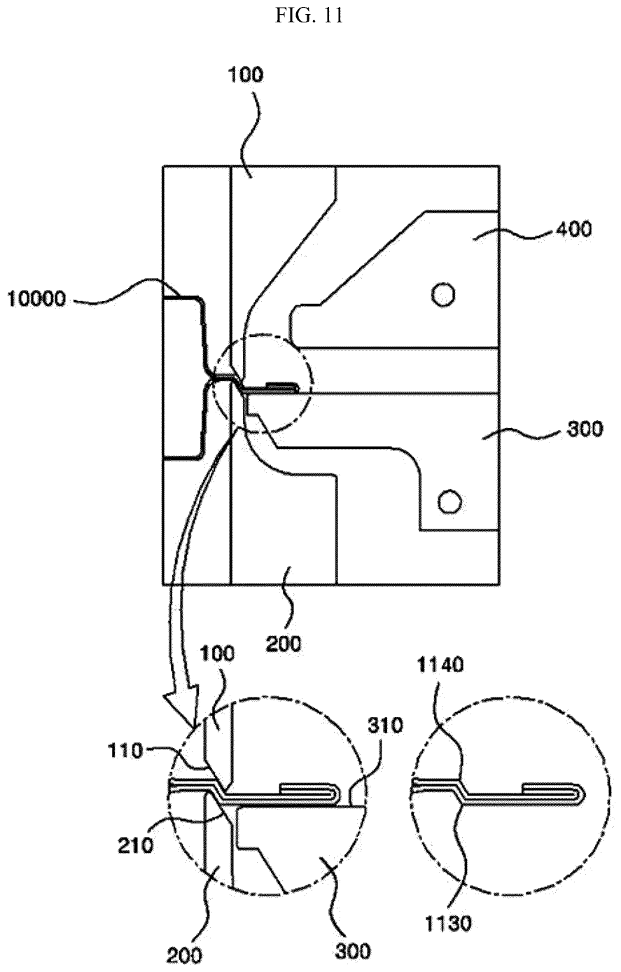

As illustrated in FIG. 9, while the press block 400 is moved, the pouch-type secondary battery is moved to the outside, and as illustrated in FIGS. 10 and 11, the lower folding blade 200 and the upper folding blade 100 are moved to form a third bent part 1130 and a fourth bent part 1140 on the side wing 1100.

In this case, by positioning the folding block 300 in the same manner as illustrated in FIG. 2, the third bent part 1130 and the fourth bent part 1140 are formed on the side wing 1100. However, since the pouch-type secondary battery is moved to the outside, the third bent part 1130 and the fourth bent part 1140 are formed inside the part of the primary folding.

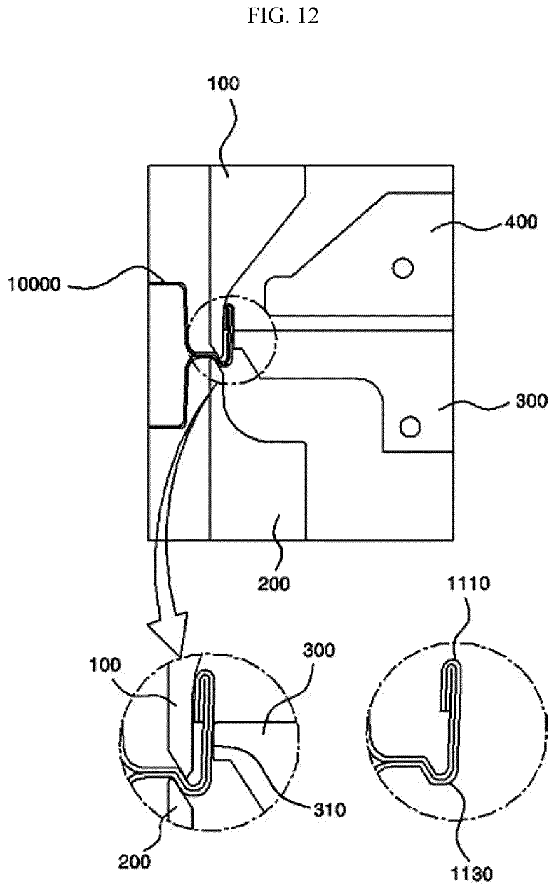

In addition, as illustrated in FIG. 12, by moving the folding block 300 upward, the third bent part 1130 is additionally bent. In the same manner as illustrated in FIG. 3, the side wing 1100 is pressed by the vertical surface 320 of the folding block 300, and the third bent part 1130 is additionally bent.

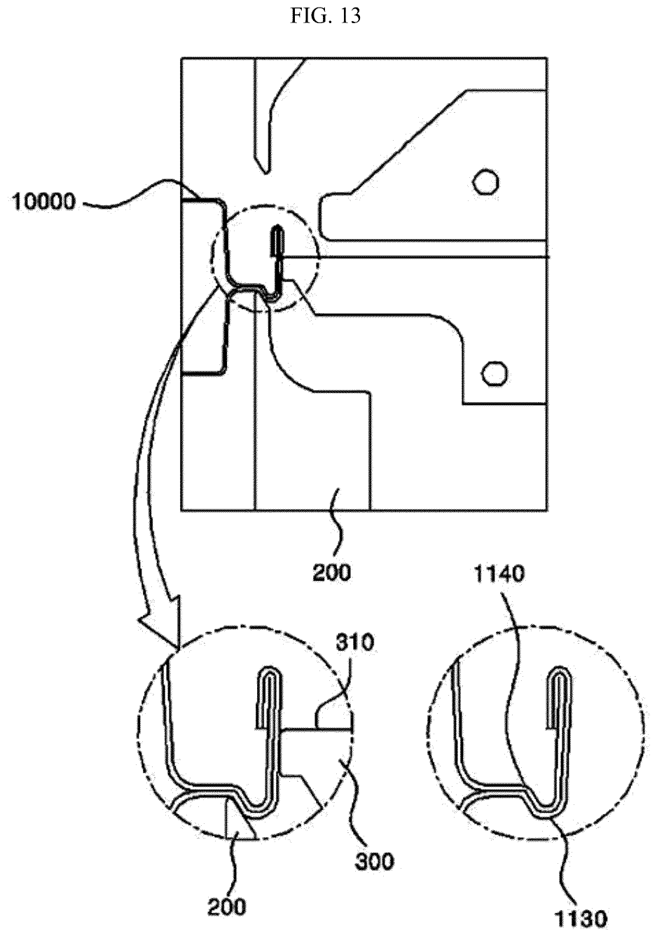

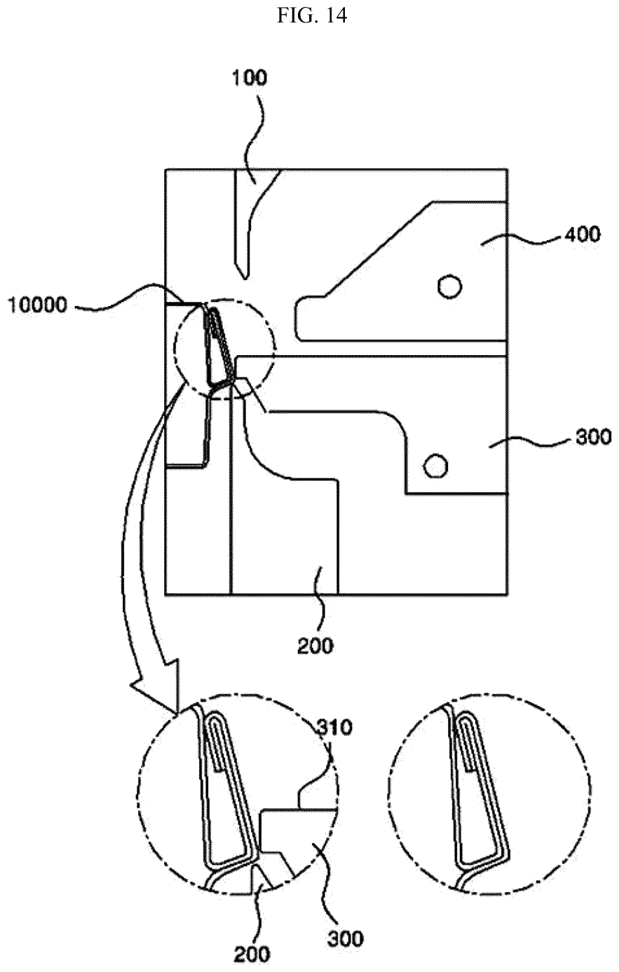

As illustrated in FIG. 13, the upper folding blade 100 is moved upward, and as illustrated in FIGS. 14 to 16, the folding block 300 is moved inward so that the vertical surface 320 pushes the side wing 1100 inward, so the first bent part 1110 folded primarily may be attached to the body 1000 of a pouch-type secondary battery.

In the prior art disclosed in Korean Patent Application Publication No. 10-2022-0040347, a secondary folding is performed by immediately folding upward a side wing whose primary folding is performed. In this case, the secondary folding is performed at a position close to the body of the pouch-type secondary battery. Since it is difficult to fold the part of the side wing close to the body of the pouch-type secondary battery to 90° due to structural characteristics thereof, the part folded to 180° in a pouch by the primary folding is difficult to be brought into close contact with the body of the pouch-type secondary battery, and the force of the folded part to be apart from the body increases.

In contrast, when using the side wing folding device for a pouch-type secondary battery of the present embodiment, the third bent part 1130 is formed at a position away from the body of the pouch-type secondary battery, and accordingly, through the formation of the third bent part 1130, the first bent part 1110 folded to 180° in the primary folding approaches the body 1000 of the pouch-type secondary battery. In this structure, even when the inner part of the third bent part 1130 is slightly folded, the first bent part 1110 located outside the third bent part 1130 may be brought into contact with the body 1000 of the pouch-type secondary battery. Furthermore, since the side wing has a less tendency to be away from the body compared to when a part of the side wing around the body of the pouch-type secondary battery is folded to 90°, the side wing has the advantage of being able to maintain a stable folded shape even when later fixed with tape, etc.

Accordingly, the side wing folding device for a pouch-type secondary battery according to the present disclosure can perform the secondary folding as well as the primary folding, and furthermore, when the secondary folding is performed, the end part folded primarily can be stably maintained to be in close contact with the body of the pouch-type secondary battery.

The present disclosure has been described above through the preferred embodiment, but the above-described embodiment is merely intended for illustrative explanations of the technical idea of the present disclosure. Those skilled in the art will understand that the embodiment can be variously modified without departing from the technical idea of the present disclosure. Therefore, the scope of protection of the present disclosure should be interpreted based on the matters stated in the claims, not the specific embodiment, and all technical ideas within the equivalent scope should be interpreted as being included in the scope of claims of the present disclosure.

1. A device for folding a side wing of a pouch-type secondary battery, the device comprising:
an upper folding blade configured to move up and down and having a first inclined surface formed on a lower end part thereof, the first inclined surface slanting from an upper part of the lower end part directed to a body of the pouch-type secondary battery toward an outer lower part thereof;
a lower folding blade located under the upper folding blade, configured to move up and down, and having a second inclined surface formed on an upper end part thereof, the second inclined surface slanting from an upper part of the upper end part directed to the body of the pouch-type secondary battery toward an outer lower part thereof;
a folding block located at an opposite side of the pouch-type secondary battery relative to the upper folding blade and the lower folding blade and configured to move up, down, left, and right, with the folding block having a first horizontal surface formed on an upper part thereof; and
a press block located above the folding block at an opposite side of the pouch-type secondary battery relative to the upper folding blade and the lower folding blade and configured to move up, down, left, and right, with the press block having a third horizontal surface formed on a lower part thereof,
wherein the folding block comprises a vertical surface formed on an end part of a side surface thereof directed to the body of the pouch-type secondary battery with the vertical surface being connected to the first horizontal surface, a third inclined surface formed under the vertical surface with the third inclined surface slanting from an upper part thereof directed to the body of the pouch-type secondary battery toward an outer lower part thereof, wherein the third inclined surface is formed to be apart by a predetermined distance outward from the vertical surface, and a fourth horizontal surface located between the vertical surface and the third inclined surface, and
the first inclined surface and the second inclined surface are configured to be engaged with each other, and the second inclined surface and the third inclined surface are configured to be engaged with each other.

2. The device of claim 1, wherein in a primary folding process in which an end part of the side wing is folded to 180°,
when the side wing is located between the first inclined surface of the upper folding blade and the second inclined surface of the lower folding blade and is deformed by being pressed, the first horizontal surface of the folding block located outside the lower folding blade is located under and supports the side wing and forms two bent parts on the side wing,
when the end part of the side wing is folded upward while the folding block is moved upward, one of the two bent parts is bent to an angle less than 90° by an angle between the first inclined surface of the upper folding blade, the second inclined surface of the lower folding blade, and the vertical surface of the folding block, and
when the side wing is folded and pressed by the second inclined surface of the lower folding blade and the third inclined surface of the folding block, the bent part that is bent to an angle less than 90° is folded to 180°.

3. The device of claim 1, wherein in a secondary folding process in which the side wing with an end part folded to 180° is folded toward the body of the secondary battery,
when the side wing is located between the first inclined surface of the upper folding blade and the second inclined surface of the lower folding blade and is deformed by being pressed, the first horizontal surface of the folding block located outside the lower folding blade is located under and supports the side wing and forms two bent parts on the side wing,
when the end part of the side wing is folded upward while the folding block is moved upward, the folding block is moved upward with the upper folding blade raised, and the end part of the side wing folded to 180° is folded toward the body of the secondary battery, and
when the vertical surface of the folding block presses the side wing, which is folded upward, toward the body, the vertical surface of the folding block protrudes more inward than the lower folding blade, and brings the end part of the side wing folded to 180° into close contact with the body of the secondary battery.

4. A side wing folding method for a pouch-type secondary battery to perform primary folding of folding an end part of a side wing to 180° by using the folding device of claim 1, the method comprising:
forming two bent parts on the side wing by supporting the side wing by a first horizontal surface of a folding block located outside a lower folding blade and under the side wing by locating the side wing between a first inclined surface of an upper folding blade and a second inclined surface of the lower folding blade to press and deform the side wing;
bending one of the two bent parts to an angle less than 90° by an angle between the first inclined surface of the upper folding blade, the second inclined surface of the lower folding blade, and a vertical surface of the folding block while the end part of the side wing is folded upward while the folding block is moved upward; and
folding the bent part, which is bent to an angle less than 90°, to 180° by folding and pressing the side wing by the second inclined surface of the lower folding blade and a third inclined surface of the folding block.

5. The method of claim 4, further comprising:
pressing the side wing, which has the bent part folded to 180°, between the first horizontal surface of the folding block and a second horizontal surface of a press block afterward.

6. A side wing folding method for a pouch-type secondary battery to perform secondary folding of folding a side wing having an end part folded to 180° toward a body of the secondary battery by the folding device of claim 1, the method comprising:
forming two bent parts on the side wing by supporting the side wing by a first horizontal surface of a folding block located outside a lower folding blade and under the side wing by locating the side wing between a first inclined surface of an upper folding blade and a second inclined surface of the lower folding blade to press and deform the side wing;
folding the end part of the side wing folded to 180° toward the body of the secondary battery after folding the end part of the side wing upward while the folding block is moved upward with the upper folding blade raised; and
bringing the end part of the side wing folded to 180°into close contact with the body of the secondary battery by protruding a vertical surface of the folding block more inward than the lower folding blade while the vertical surface of the folding block presses the side wing, which is folded upward, toward the body.
